(19) United States
(12) Patent Application Publication
(10) Pub. No.: US 2024/0258645 A1
(43) Pub. Date: Aug. 1, 2024

(54) LITHIUM ION-CONDUCTING MATERIAL WITH IMPROVED DENDRITE RESISTANCE

(71) Applicant: SCHOTT AG, Mainz (DE)

(72) Inventors: Sebastian LEUKEL, Mainz (DE); Nina HOINKIS, Mainz (DE); Jörg SCHUHMACHER, Kornwestheim (DE); Meike SCHNEIDER, Taunusstein (DE); Andreas ROTERS, Mainz (DE)

(73) Assignee: SCHOTT AG, Mainz (DE)

(21) Appl. No.: 18/602,415

(22) Filed: Mar. 12, 2024

Related U.S. Application Data
(63) Continuation of application No. PCT/EP2022/080001, filed on Oct. 26, 2022.

(30) Foreign Application Priority Data
Oct. 29, 2021 (DE) 102021128377.9

(51) Int. Cl. H01M 50/437; H01M 10/0525; H01M 50/403; H01M 50/497

(52) U.S. Cl. CPC H01M 50/437; H01M 10/0525; H01M 50/403; H01M 50/497

(57) ABSTRACT

The present invention relates to a lithium ion-conducting material, especially a glass-ceramic, having improved dendrite stability (stability to the formation of dendrites), and to use and a process for production.

### CROSS-REFERENCE TO RELATED APPLICATIONS

This application is a continuation of PCT International Application No. PCT/EP2022/080001, filed Oct. 26, 2022, which claims the benefit of German Patent application No. 10 2021 128 377.9, filed Oct. 29, 2021, the contents of each of which are incorporated herein by reference.

### FIELD OF THE INVENTION

The present invention relates to a lithium ion-conducting material, especially a glass-ceramic, having improved dendrite stability (stability to the formation of dendrites), and to use and a process for production.

### BACKGROUND OF THE INVENTION

All-solid-state batteries (ASSB), because of their high energy density and safety, are considered to be the future of energy storage technologies/electromobility. The centerpiece of this innovation is replacement of the liquid electrolyte by a solid ion-conducting separator, which also permits the use of anode materials including lithium metal if the separator itself is stable to lithium (for example when lithium lanthanum zirconate (LLZO) is used). In the course of charging, however, the lithium deposited at the anode can grow into the separator up to the cathode side. This is called dendrite formation. If such a dendrite forms, the result is a short circuit. The higher the current density in the course of charging, the easier it is for the unwanted dendrites to form. It is therefore necessary to provide a separator material that suppresses dendrite formation even in the case of higher current densities, i.e. has a critical current density (CCD).

### SUMMARY OF THE INVENTION

It is therefore an object of the invention to overcome the disadvantages from the prior art. The object is achieved by the subject matter of the claims. The object is more particularly achieved by a lithium ion-conducting material comprising a crystalline phase and an amorphous phase, wherein the lithium ion-conducting material has a critical current density of more than 0.5 mA/cm².

### BRIEF DESCRIPTION OF THE FIGURES

FIG. 1 shows electron micrographs of sintered separators composed of the materials a) Ex. 1 and b) Ex. V1. The SiO₂-rich amorphous phase in Ex. 1 is deposited at the grain boundaries (dark regions).

### DETAILED DESCRIPTION OF THE INVENTION

The combination of a lithium ion-conducting crystalline phase, for example Li-stable LLZO (especially Ta- or Al-doped), with an amorphous phase, especially in the grain boundaries of the sintered separator, can significantly increase the CCD compared to materials without such an amorphous phase or an amorphous phase without glass formers (pure Li₂O) or with a low glass former content based on the total mass of the crystalline and amorphous phase, i.e. based on the total mass of the lithium ion-conducting material. The glass former content may advantageously, based on the total mass of the lithium ion-conducting material, be at least 0.05% by weight.

It may be a particular feature of the amorphous phase that it contains, as well as Li₂O (for lithium ion conductivity), at least one glass former (especially selected from SiO₂, Al₂O₃, B₂O₃, P₂O₅), where SiO₂ and/or P₂O₅ is obligatory and the proportion of the sum total of SiO₂ and P₂O₅ based on the total mass of the glass formers is at least 25% by weight, i.e. the respective percentages by weight of (SiO₂+P₂O₅)/(SiO₂+B₂O₃+Al₂O₃+P₂O₅)≥0.25. This minimum content of SiO₂ and/or P₂O₅ is advantageous in order to stabilize the amorphous phase (also referred to as glass phase). B₂O₃ is not preferred as the sole glass former since there can be phase separation in the glass phase and in that case the positive effect on the CCD is not achieved. Al₂O₃ is likewise not preferred as the sole glass former since small amounts of Al₂O₃ can dissolve in the crystalline phase and hence make it more difficult to create the amorphous phase, and, moreover, relatively large amounts of Al₂O₃ can lead to unwanted secondary phases.

Exotic glass formers, such as Nb₂O₅, Ta₂O₅, PbO, Bi₂O₃, GeO₂, SeO₃, TeO₃, Sb₂O₃ or As₂O₃, are insufficiently effective to create the amorphous phase in the context of the invention, since they do not dissolve in the crystalline phase in the case of Nb₂O₅ and Ta₂O₅ or are reduced in contact with lithium metal because of their polyvalency and hence reduce the CCD in the case of PbO, Bi₂O₃, GeO₂, SeO₃, TeO₃, Sb₂O₃ and As₂O₃. The amount of polyvalent elements, especially the sum total of the proportions of PbO, Bi₂O₃, GeO₂, SeO₃, TeO₃, Sb₂O₃ and As₂O₃, in the lithium ion-conducting material, especially in the glass-ceramic, should preferably be <0.5% by weight, for example not more than 0.2% by weight or not more than 0.1% by weight. The lithium ion-conducting material may, for example, even be free of PbO, Bi₂O₃, GeO₂, SeO₃, TeO₃, Sb₂O₃ and/or As₂O₃.

The composition of the amorphous phase may be chosen such that there is no occurrence of unwanted interaction with LLZO crystals (for example transformation to the tetragonal modification of LLZO that has lower conductivity). For instance, transformation of the cubic modification to the lower-conductivity tetragonal modification of LLZO may occur when the Li₂O content of the amorphous phase is too high. Therefore, the Li₂O content of the amorphous phase may be limited, for example, to not more than 5.00% by weight, not more than 4.50% by weight, not more than 4.00% by weight, or not more than 3.50% by weight, based on the total mass of the lithium ion-conducting material. The Li₂O content of the amorphous phase, based on the total mass of the lithium ion-conducting material, may, for example, be at least 0.05% by weight, at least 0.20% by weight, at least 0.40% by weight, or at least 0.60% by weight. The Li₂O content of the amorphous phase may, based on the total mass of the lithium ion-conducting material, for example, be within a range from 0.05% to 5.00% by weight, from 0.20% to 4.50% by weight, from 0.40% to 4.00% by weight, or from 0.60% to 3.50% by weight.

The glass former content of the amorphous phase, based on the total mass of the lithium ion-conducting material, may, for example, be at least 0.05% by weight, preferably at least 0.10% by weight, at least 0.15% by weight, at least 0.20% by weight, at least 0.25% by weight, at least 0.30% by weight, at least 0.35% by weight, at least 0.40% by weight, at least 0.45% by weight, or at least 0.50% by weight. The glass former content of the amorphous phase, based on the total mass of the lithium ion-conducting material, may, for example, be at most 4.00% by weight, at most 3.50% by weight, at most 3.00% by weight, at most 2.50% by weight, at most 2.00% by weight, at most 1.50% by weight, at most 1.00% by weight, at most 0.80% by weight, at most 0.75% by weight, or at most 0.70% by weight. The glass former content of the amorphous phase, based on the total mass of the lithium ion-conducting material, may, for example, be within a range from 0.05% to 4.00% by weight, from 0.10% to 3.50% by weight, from 0.15% to 3.00% by weight, from 0.20% to 2.50% by weight, from 0.25% to 2.00% by weight, from 0.30% to 1.50% by weight, from 0.35% to 1.00% by weight, from 0.40% to 0.80% by weight, from 0.45% to 0.75, or from 0.50% to 0.70% by weight.

The glass former content of the lithium ion-conducting material, based on the total mass of the lithium ion-conducting material, may, for example, be at least 0.05% by weight, preferably at least 0.10% by weight, at least 0.15% by weight, at least 0.20% by weight, at least 0.25% by weight, at least 0.30% by weight, at least 0.35% by weight, at least 0.40% by weight, at least 0.45% by weight, or at least 0.50% by weight. The glass former content of the lithium ion-conducting material, based on the total mass of the lithium ion-conducting material, may, for example, be at most 4.00% by weight, at most 3.50% by weight, at most 3.00% by weight, at most 2.50% by weight, at most 2.00% by weight, at most 1.50% by weight, at most 1.00% by weight, at most 0.80% by weight, at most 0.75% by weight, or at most 0.70% by weight. The glass former content of the lithium ion-conducting material, based on the total mass of the lithium ion-conducting material, may, for example, be within a range from 0.05% to 4.00% by weight, from 0.10% to 3.5% by weight, from 0.15% to 3.00% by weight, from 0.20% to 2.50% by weight, from 0.25% to 2.00% by weight, from 0.30% to 1.50% by weight, from 0.35% to 1.00% by weight, from 0.40% to 0.80% by weight, from 0.45% to 0.75%, or from 0.50% to 0.70% by weight.

Since the glass former is in the amorphous phase and not in the crystalline phase, the glass former content of the amorphous phase (based on the total mass of the lithium ion-conducting material) corresponds to the glass former content of the lithium ion-conducting material (based on the total mass of the lithium ion-conducting material). An exception is formed here by Al₂O₃, which, when the crystalline phase has a garnet structure, especially when it is lithium lanthanum zirconate (LLZO), may also be in the crystalline phase. However, the solubility of Al₂O₃ in a crystalline phase with garnet structure is limited. Depending slightly on the composition and production process, the solubility is about 0.1 mol of Al₂O₃ per formula unit of LLZO, i.e. Li_{6.4}Al_{0.2}La₃Zr₁₂O₁₂. This is also true of variants of this garnet that have been doped with one or more divalent cations M^{II}, one or more trivalent cations M^{III}, one or more tetravalent cations M^{IV} and one or more pentavalent cations M^{V}. Therefore, in the calculation of the amorphous phase from the composition, Al₂O₃ is included in the crystalline phase up to an amount of 0.1 mol of Al₂O₃ per formula unit of the garnet. Excess Al₂O₃, i.e. the proportion over and above the amount of 0.1 mol of Al₂O₃ per formula unit of the garnet, is included in the amorphous phase.

The amorphous phase can be produced by the production process via the melt, where the solidification forms not only crystalline LLZO but also the amorphous phase comprising, especially consisting of, excess Li₂O and the glass formers. The glass formers do not “fit” into the LLZO structure because of their small ionic radius. Moreover, the amorphous phase can also be produced separately, for example via a melting process, and then added to and mixed with the crystalline phase. This can be achieved, for example, by grinding crystalline phase and amorphous phase. Other production processes and mixing processes are likewise conceivable.

In the sintering of a glass-ceramic, for example in the case of use or for use as a separator, the amorphous phase accumulates at the grain boundaries in particular.

The present invention can achieve a distinct increase in CCD, especially a CCD of more than 0.5 mA/cm², for example at least 1.0 mA/cm² or more. Complex further process steps, for example the insertion of an interlayer between anode and separator, can be avoided by the solution of the invention.

The lithium ion-conducting material of the invention, especially the glass-ceramic or the lithium ion-conducting LLZO material of the invention, may be used on its own, or sintered together with other battery materials, to give an inorganic ceramic electrolyte in rechargeable lithium ion batteries, particularly in all-solid-state batteries (ASSB). Firstly, use as a separator is conceivable: when introduced between the electrodes, it prevents an unwanted short circuit and hence ensures the functionality of the overall system. The separator of the invention features improved dendrite stability, which permits charging at higher current density without a short circuit (fast charging). Secondly, co-sintering with the electrode materials is conceivable: in that case, the solid-state electrolyte brings about the transport of the relevant charge carriers (lithium ions) to and from the electrode materials and the conductive electrodes—depending on whether the battery is currently being discharged or charged.

The material of the present invention is a lithium ion-conducting material, especially a glass-ceramic. Conductivity may, for example, be at least 1*10⁻⁵ S/cm, at least 3*10⁻⁵ S/cm, at least 7*10⁻⁵ S/cm, at least 1*10⁻⁴ S/cm or at least 2*10⁻⁴ S/cm. Conductivity may, for example, be at most 1*10⁻² S/cm, at most 5*10⁻³ S/cm, at most 4*10⁻³ S/cm, at most 3*10⁻³ S/cm, or at most 2*10⁻³ S/cm. Conductivity may, for example, be within a range from 1*10⁻⁵ S/cm to 1*10⁻² S/cm, from 3*10⁻⁵ S/cm to 5*10⁻³ S/cm, from 7*10⁻⁵ S/cm to 4*10⁻³ S/cm, from 1*10⁻⁴ S/cm to 3*10⁻³ S/cm, or from 2*10⁻⁴ S/cm to 2*10⁻³ S/cm. Conductivity can be determined by impedance spectroscopy. For this purpose, the material can be ground to a size of d₅₀=1 μm, then pressed to compacts, and these can be sintered at 1130° C. for 30 min. In order to prevent degradation of the samples in contact with water, the sample preparation can be conducted in an anhydrous manner.

The lithium ion-conducting material of the present invention comprises a crystalline phase and an amorphous phase. The amorphous phase may especially contain Li₂O and at least one glass former selected from SiO₂, B₂O₃, Al₂O₃, P₂O₅ and combinations of two or more of these, where the sum total of the proportions of SiO₂ and P₂O₅ based on the total mass of the glass formers is at least 25%, i.e. the respective percentages by weight of (SiO₂+P₂O₅)/(SiO₂+B₂O₃+Al₂O₃+P₂O₅)≥0.25. The sum total of the proportions of SiO₂ and P₂O₅ based on the total mass of the glass formers may, for example, be at least 30%, at least 40%, at least 50%, at least 60%, at least 70%, at least 80%, at least 90%, at least 95%, or even 100%. The lithium ion-conducting material may thus be free of B₂O₃ and Al₂O₃.

SiO₂ is a particularly preferred glass form of the present invention. The proportion of SiO₂ based on the total mass of the glass formers may, for example, be at least 25%, i.e. the respective percentages by weight of (SiO₂)/(SiO₂+B₂O₃+Al₂O₃+P₂O₅)≥0.25. The proportion of SiO₂ based on the total mass of the glass formers may, for example, be at least 30%, at least 40%, at least 50%, at least 60%, at least 70%, at least 80%, at least 90%, at least 95%, or even 100%. The lithium ion-conducting material may thus be free of P₂O₅, B₂O₃ and Al₂O₃. In particular, the glass former may be SiO₂. SiO₂ is particularly advantageous in order to distinctly increase the critical current density.

The proportion of Li₂O in the lithium ion-conducting material of the invention may, for example, be at least 10.0% by weight, at least 10.5% by weight, or at least 11.0% by weight. The proportion of Li₂O in the lithium ion-conducting material of the invention may, for example, be at most 15.0% by weight, at most 14.5% by weight, or at most 14.0% by weight. The proportion of Li₂O in the lithium ion-conducting material of the invention may, for example, be within a range from 10.0% to 15.0% by weight, from 10.5% to 14.5% by weight, or from 11.0% to 14.0% by weight.

The proportion of the sum total of rare earth oxides RE₂O₃, preferably La₂O₃, Gd₂O₃ and/or Y₂O₃, in the lithium ion-conducting material of the invention may, for example, be at least 45% by weight, at least 48% by weight, or at least 50% by weight. The proportion of the sum total of rare earth oxides RE₂O₃, preferably La₂O₃, Gd₂O₃ and/or Y₂O₃, in the lithium ion-conducting material of the invention may, for example, be at most 70% by weight, at most 65% by weight, or at most 60% by weight. The proportion of the sum total of rare earth oxides RE₂O₃, preferably La₂O₃, Gd₂O₃ and/or Y₂O₃, in the lithium ion-conducting material of the invention may, for example, be within a range from 45% to 70% by weight, from 48% to 65% by weight, or from 50% to 60% by weight.

The proportion of the sum total of ZrO₂ and HfO₂ in the lithium ion-conducting material of the invention may, for example, be at least 17% by weight, at least 18% by weight, or at least 19% by weight. The proportion of the sum total of ZrO₂ and HfO₂ in the lithium ion-conducting material of the invention may, for example, be at most 35% by weight, at most 33% by weight, or at most 31% by weight. The proportion of the sum total of ZrO₂ and HfO₂ in the lithium ion-conducting material of the invention may, for example, be within a range from 17% to 35% by weight, from 18% to 33% by weight, or from 19% to 31% by weight.

The proportion of SiO₂ in the lithium ion-conducting material of the invention may, for example, be at least 0.05% by weight, preferably at least 0.10% by weight, at least 0.15% by weight, at least 0.20% by weight, at least 0.25% by weight, at least 0.30% by weight, at least 0.35% by weight or at least 0.40% by weight. The proportion of SiO₂ in the lithium ion-conducting material of the invention may, for example, be at most 2.00% by weight, at most 1.75% by weight, at most 1.50% by weight, at most 1.25% by weight, at most 1.00% by weight, at most 0.90, at most 0.85% by weight, or at most 0.80% by weight. The proportion of SiO₂ in the lithium ion-conducting material of the invention may, for example, be within a range from 0.05% to 2.00% by weight, from 0.10% to 1.75% by weight, from 0.15% to 1.50% by weight, from 0.20% to 1.25% by weight, from 0.25% to 1.00% by weight, from 0.30% to 0.90% by weight, from 0.35% to 0.85% by weight, or from 0.40% to 0.80% by weight.

The proportion of the sum total of Ta₂O₅, Nb₂O₅ and Al₂O₃ in the lithium ion-conducting material of the invention may, for example, be at least 0.5% by weight, at least 0.75% by weight, or at least 1% by weight. The proportion of the sum total of Ta₂O₅, Nb₂O₅ and Al₂O₃ in the lithium ion-conducting material of the invention may, for example, be at most 15% by weight, at most 13.5% by weight, or at most 12% by weight. The proportion of the sum total of Ta₂O₅, Nb₂O₅ and Al₂O₃ in the lithium ion-conducting material of the invention may, for example, be within a range from 0.5% to 15% by weight, from 0.75% to 13.5% by weight, or from 1% to 12% by weight.

The lithium ion-conducting material of the invention may, for example, comprise the following components in the specified proportions (in % by weight):

| Component | Min | Max |
|---|---|---|
| Li₂O | 10 | 15 |
| La₂O₃ | 45 | 60 |
| ZrO₂ | 17 | 35 |
| HfO₂ | 0 | 5 |
| SiO₂ | 0.05 | 2 |
| Ta₂O₅ | 0 | 15 |
| Nb₂O₅ | 0 | 15 |
| Al₂O₃ | 0 | 6 |
| Gd₂O₃ | 0 | 10 |
| Y₂O₃ | 0 | 4 |

Further preferably, the lithium ion-conducting material of the invention may comprise, for example, the following components in the specified proportions (in % by weight):

| Component | Min | Max |
|---|---|---|
| Li₂O | 10 | 15 |
| La₂O₃ | 45 | 60 |
| ZrO₂ | 17 | 30 |
| HfO₂ | 0 | 5 |
| SiO₂ | 0.05 | 2 |
| Ta₂O₅ | 3 | 15 |

More preferably, the lithium ion-conducting material of the invention may comprise, for example, the following components in the specified proportions (in % by weight):

| Component | Min | Max |
|---|---|---|
| Li₂O | 10 | 15 |
| La₂O₃ | 45 | 60 |
| ZrO₂ | 17 | 30 |
| HfO₂ | 0 | 5 |
| SiO₂ | 0.05 | 2 |
| Nb₂O₅ | 3 | 15 |

More preferably, the lithium ion-conducting material of the invention may comprise, for example, the following components in the specified proportions (in % by weight):

| Component | Min | Max |
|---|---|---|
| Li₂O | 10 | 15 |
| La₂O₃ | 45 | 60 |
| ZrO₂ | 20 | 35 |
| HfO₂ | 0 | 5 |
| SiO₂ | 0.05 | 2 |
| Al₂O₃ | 0.5 | 6 |

More preferably, the lithium ion-conducting material of the invention may comprise, for example, the following components in the specified proportions (in % by weight):

| Component | Min | Max |
|---|---|---|
| Li₂O | 10 | 15 |
| La₂O₃ | 45 | 60 |
| ZrO₂ | 20 | 35 |
| HfO₂ | 0 | 5 |
| SiO₂ | 0.05 | 2 |
| Al₂O₃ | 0.5 | 6 |
| Gd₂O₃ | 0.5 | 10 |
| Y₂O₃ | 0 | 4 |

More preferably, the lithium ion-conducting material of the invention may comprise, for example, the following components in the specified proportions (in % by weight):

| Component | Min | Max |
|---|---|---|
| Li₂O | 10 | 15 |
| La₂O₃ | 45 | 60 |
| ZrO₂ | 20 | 35 |
| HfO₂ | 0 | 5 |
| SiO₂ | 0.05 | 2 |
| Al₂O₃ | 0.5 | 6 |
| Gd₂O₃ | 0.5 | 10 |
| Y₂O₃ | 0.5 | 4 |

Where the present disclosure says that the material is free of a component or does not contain a component, this means that the component may be present as an impurity at most. This means that it is not added in significant amounts. Insignificant amounts according to the invention are amounts of at most 0.05% by weight or at most 0.04% by weight.

The proportion of the amorphous phase in the lithium ion-conducting material corresponds in particular to the sum total of the proportion of Li₂O in the amorphous phase (based on the total mass of the lithium ion-conducting material) and the proportion of the at least one glass former in the amorphous phase (based on the total mass of the lithium ion-conducting material). If the proportion of the amorphous phase in the lithium ion-conducting material is very high, the lithium ion conductivity of the lithium ion-conducting material can be impaired. It is therefore advantageous to impose an upper limit on the proportion of the amorphous phase in the lithium ion-conducting material. The proportion of the amorphous phase in the lithium ion-conducting material is preferably less than 5.0% by weight, especially at most 4.9% by weight, at most 4.8% by weight, at most 4.7% by weight, at most 4.6% by weight, at most 4.5% by weight, at most 4.4% by weight, at most 4.3% by weight, at most 4.2% by weight, at most 4.1% by weight, or at most 4.0% by weight. The proportion of the amorphous phase in the lithium ion-conducting material may, for example, at least 0.1% by weight, at least 0.15% by weight, at least 0.2% by weight, at least 0.3% by weight, at least 0.4% by weight, at least 0.5% by weight, at least 0.6% by weight, at least 0.7% by weight, at least 0.8% by weight, at least 0.9% by weight, or at least 1.0% by weight. The proportion of the amorphous phase in the lithium ion-conducting material may, for example, be within a range from 0.1% to <5.0% by weight, from 0.15 to 4.9% by weight, from 0.2% to 4.8% by weight, from 0.3% to 4.7% by weight, from 0.4% to 4.6% by weight, from 0.5% to 4.5% by weight, from 0.6% to 4.4% by weight, from 0.7% to 4.3% by weight, from 0.8% to 4.2% by weight, from 0.9% to 4.1% by weight, or from 1.0% to 4.0% by weight.

The proportions of the crystalline phase and the amorphous phase in the lithium ion-conducting material are especially determined on the basis of the composition of the lithium ion-conducting material. For this purpose, proceeding from the empirical formula of the crystalline phase, the composition is converted from % by weight to at %. Subsequently, the elements that form the crystalline phase according to the empirical formula are assigned thereto (the procedure is analogous in the case of multiple crystalline phases). Any excess of Li, O and the glass formers is assigned to the amorphous phase. The procedure is simplified if the composition in at % is normalized to one of the stoichiometric factors from the empirical formula of the crystalline phase. This is shown hereinafter using the example of the empirical formula of LLZO, Li_{7-3x+y-z}AlₓM_{y}^{II}M_{3-y}^{III}M_{2-z}^{IV}M_{z}O₁₂: first of all, the composition in at % is normalized to M^{II}+M^{III}=3 (or alternatively to M^{IV}+M^{V}=2) in order to obtain the composition in pfu (parts per formula unit). This composition is divided into the crystal-forming components and the components that are not incorporated into the stoichiometric crystal: excess Li and O and Si, P, B, Al (up to an amount of 0.2 pfu of Al, this is included in the crystal-forming components because of limited solubility in the garnet structure. If more Al is present, the difference from 0.2 pfu is assigned to the amorphous phase). Subsequently, the amorphous phase in pfu is converted back to % by weight of the oxides present using the respective atomic masses. The proportion by weight of the amorphous phase in the lithium ion-conducting material is the sum total of the proportions by weight of the oxides in the amorphous phase (based on the total mass of the lithium ion-conducting material) in % by weight.

The lithium ion-conducting material of the present invention has a critical current density of more than 0.5 mA/cm². The critical current density may, for example, be at least 0.6 mA/cm², at least 0.7 mA/cm², at least 0.8 mA/cm², at least 0.9 mA/cm², or at least 1.0 mA/cm². The critical current density may, for example, be at most 20 mA/cm², at most 18 mA/cm², at most 16 mA/cm², at most 14 mA/cm², at most 12 mA/cm², or at most 10 mA/cm². The critical current density may, for example, be within a range from >0.5 to 20 mA/cm², from 0.6 to 18 mA/cm², from 0.7 to 16 mA/cm², from 0.8 to 14 mA/cm², from 0.9 to 12 mA/cm², or from 1.0 to 10 mA/cm². In some embodiments, the critical current density is at most 7.5 mA/cm², at most 5.0 mA/cm², at most 4.0 mA/cm², at most 3.0 mA/cm², at most 2.0 mA/cm², or at most 1.2 mA/cm².

Critical current density can be determined by contacting disk-shaped sintered blanks (diameter 8.5 mm, height 1 mm) with lithium on the two opposite sides. These are subjected to cycling with increasing current density from 50 to 2000 μA/cm² with an increment of 50 μA/cm², and the voltage is recorded. One cycle is conducted for each current density, and the charging and discharging operations are each 30 min. The critical current density is defined as that current density at which there is a short circuit of the cell. At this current density, the voltage no longer follows current density according to Ohm's law, and there is instead an immediate drop in voltage. In order to produce the sintered blanks, the lithium ion-conducting material can be ground to a size of d₅₀=1 μm, then pressed to compacts, and these can be sintered at 1130° C. for 30 min. In order to avoid degradation of the samples in contact with water, the sample preparation can be conducted under anhydrous conditions.

The lithium ion-conducting material of the present invention may especially be a glass-ceramic.

A glass-ceramic in the context of the present invention is a material which is produced proceeding from a homogeneous melt of the components by cooling and spontaneous crystallization or by cooling and a subsequent controlled ceramization process. Before, during or after the cooling, a shaping step or comminution process may be conducted.

The lithium ion-conducting material of the invention comprises a crystalline phase and an amorphous phase. The crystalline phase may comprise a main crystal phase. The main crystal phase is that component having the highest proportion in % by weight of the crystalline phase of the lithium ion-conducting material. The main crystal phase especially has a proportion of at least 50% by weight of the crystalline phase of the lithium ion-conducting material, for example more than 50% by weight, at least 60% by weight, at least 70% by weight, at least 80% by weight, at least 90% by weight, at least 95% by weight, or even 100%. The crystalline phase of the lithium ion-conducting material may thus consist of the main crystal phase.

The main crystal phase may especially have a garnet structure. The main crystal phase may alternatively have a rock salt structure, a perovskite structure, an anti-perovskite structure or a NASICON structure. The main crystal phase may, for example, be in the cubic crystal system. The main crystal phase may comprise or consist of, for example, lithium lanthanum zirconate (LLZO).

The main crystal phase of the crystalline phase of the lithium ion-conducting material may especially have the empirical formula Li_{7-3x+y-z}AlₓM_{y}^{II}M_{3-y}^{III}M_{2-z}^{IV}M_{z}^{V}O_{12±δ} where M^{II} comprises one or more divalent cations, M^{III} comprises one or more trivalent cations, M^{IV} comprises one or more tetravalent cations and M^{V} comprises one or more pentavalent cations, and where x+z>0, y<1 and δ<0.5. More preferably, M^{III} comprises one or more lanthanides and/or yttrium. More preferably, M^{IV} comprises zirconium or hafnium. More preferably, M^{V} comprises niobium or tantalum. More preferably, M^{III} comprises one or more lanthanides and/or yttrium, M^{IV} comprises zirconium or hafnium, and M^{V} comprises niobium or tantalum.

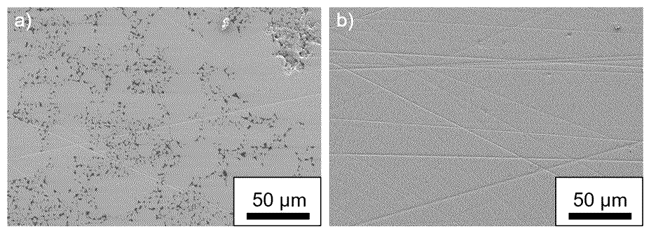

The lithium ion-conducting material of the invention comprises a crystalline phase and an amorphous phase. The crystalline phase may take the form, for example, of crystallites separated by grain boundaries in the lithium ion-conducting material. The amorphous phase may especially be present at the grain boundaries (FIG. 1). The amorphous phase may have a density, for example, of at least 1.5 g/cm³.

The present invention also relates to a process for producing a lithium ion-conducting material, especially the lithium ion-conducting material of the present invention. The process may especially comprise the following steps:
melting the starting materials,
cooling the melt.

The starting materials (also referred to as raw materials) may be melted, for example, in a skull crucible (especially one open at the top). Preferably, the raw materials are mixed and the resultant batch is preheated. For this purpose it is possible to use a burner heater in particular. The preheating can achieve a minimum conductivity. On attainment of what is called the coupling temperature, further heating and homogenization of the melt can be achieved by high-frequency input coupling, especially via an induction coil. In order to improve the homogenization of the melt, it can be stirred, especially with a water-cooled stirrer. On completion of homogenization, it is possible, for example, to take direct samples from the melt (rapid cooling), while the rest of the melt can be cooled down gradually by switching off the high frequency.

The material produced in this way can be converted to a lithium ion-conducting, in particular glass-ceramic, material with a garnetlike main crystal phase either by direct solidification from the melt or by quenching, followed by a thermal treatment (ceramization). The samples taken directly from the melt, irrespective of cooling, show spontaneous crystallization, and so it is possible to dispense with a downstream ceramization treatment.

The present invention also relates to the use of the lithium ion-conducting material of the invention in solid-state lithium ion batteries, especially as separator. The lithium ion-conducting material can also be used in the anode and/or cathode, especially after co-sintering with the electrode materials.

The present invention also relates to solid-state lithium ion batteries comprising the lithium ion-conducting material of the present invention.

### EXAMPLES

Table 1 below shows one inventive example 1 and two comparative examples V1 and V2.

TABLE 1

| | Ex. 1 | Ex. V1 | Ex. V2 |
|---|---|---|---|
| % by weight | | | |
| Li₂O | 13.9 | 11.2 | 12.1 |
| La₂O₃ | 53.4 | 55.7 | 54.8 |
| ZrO₂ | 20.7 | 21.3 | 21.3 |
| HfO₂ | 0.4 | 0.4 | 0.4 |
| SiO₂ | 0.6 | 0.04* | 0.04* |
| Ta₂O₅ | 11.1 | 11.4 | 11.4 |
| at % | | | |
| Li | 31.76 | 27.91 | 29.32 |
| La | 11.19 | 12.73 | 12.18 |
| Zr | 5.74 | 6.44 | 6.26 |
| Hf | 0.06 | 0.07 | 0.07 |
| Si | 0.32 | 0.02 | 0.02 |
| Ta | 1.72 | 1.92 | 1.87 |
| O | 49.21 | 50.91 | 50.29 |
| pfu [normalized | | | |
| to La = 3] | | | |
| Li | 8.51 | 6.58 | 7.22 |
| La | 3 | 3 | 3 |
| Zr | 1.54 | 1.52 | 1.54 |
| Hf | 0.02 | 0.02 | 0.02 |
| Si | 0.09 | 0.01 | 0.01 |
| Ta | 0.46 | 0.45 | 0.46 |
| O | 13.19 | 12.00 | 12.39 |
| Crystalline phase [pfu] | | | |
| Li | 6.54 | 6.55 | 6.54 |
| La | 3.00 | 3.00 | 3.00 |
| Zr | 1.54 | 1.52 | 1.54 |
| Hf | 0.02 | 0.02 | 0.02 |
| Si | | | |
| Ta | 0.46 | 0.45 | 0.46 |
| O | 12.03 | 11.97 | 12.04 |
| Amorphous phase [pfu] | | | |
| Li | 1.97 | 0.03 | 0.68 |
| La | | | |
| Zr | | | |
| Hf | | | |
| Si | 0.09 | 0.006 | 0.006 |
| Ta | | | |
| O | 1.16 | 0.03 | 0.35 |
| Amorphous phase (% by | | | |
| weight based on total | | | |
| mass) | | | |
| Li₂O | 3.2 | 0.05 | 1.24 |
| SiO₂ | 0.6 | 0.04 | 0.04 |
| Conductivity [S/cm] | 7 *10⁻⁴ | 9 *10⁻⁴ | 9 *10⁻⁴ |

*SiO₂ content in the case of V1 and V2 via raw materials and process, no SiO₂ actively added

The raw materials were mixed in accordance with the compositions according to table 1 and introduced into a skull crucible open at the top. In order to compensate for the evaporation of Li₂O, an excess of about 5% based on the amount of Li₂O was used. The batch first had to be preheated in order to achieve a certain minimum conductivity. For this purpose, a burner heater was used. On attainment of the coupling temperature, the further heating and homogenizing of the melt was achieved by high-frequency input coupling via an induction coil. In order to improve the homogenization of the melts, they were stirred with a water-cooled stirrer. On completion of homogenization, direct samples were taken from the melt (rapid cooling), while the rest of the melt was cooled gradually by switching off the high frequency.

The material produced in this way can be converted to a lithium ion-conducting, in particular glass-ceramic, material with a garnetlike main crystal phase either by direct solidification from the melt or by quenching, followed by a thermal treatment (ceramization). The samples taken directly from the melt, irrespective of cooling, show spontaneous crystallization, and so it is possible to dispense with a downstream ceramization treatment. The glass-ceramics thus obtained were used to produce samples for impedance spectroscopy in order to determine conductivity and CCD (critical current density). For this purpose, the material was ground to a size of d₅₀=1 μm, then pressed to compacts, and these were sintered at 1130° C. for 30 min. In order to prevent degradation of the samples in contact with water, the sample preparation was conducted under anhydrous conditions.

For the crystalline phase and the amorphous phase, the composition is reported in each case as atoms per formula unit (pfu) of lithium lanthanum zirconate. The amorphous phase is oxidic, and the charge of the elements/cations is therefore balanced by oxygen (O²⁻). For this purpose, the composition in % by weight is first converted to at %. Subsequently, the composition in at % is normalized to La=3 in order to obtain the composition in pfu. This composition is divided into the LLZO-forming components Li, La, Zr, Hf, Ta, O, and the amorphous phase (components that are not incorporated into the stoichiometric LLZO crystal: Si and excess Li and O). The composition of the stoichiometric LLZO crystal is assumed to be Li₇₋ₓLa₃Zr_{2-x-y}TaₓHf_{y}O_{12±δ}. This division of the composition is based on the assumption that all elements that can form the stoichiometric LLZO crystal are indeed present as LLZO crystal, whereas the elements that cannot be incorporated or are present in excess are present as amorphous phases. Subsequently, the amorphous phase in pfu is converted back to % by weight using the respective atomic masses, in order to obtain the proportion of oxides in % by weight based on the total mass of the lithium ion-conducting material.

The weight of the amorphous phase (table 2) is the sum total of the oxides in the amorphous phase in % by weight from table 1.

In order to determine the critical current density (CCD), the disk-shaped sintered blanks (diameter 8.5 mm, height 1 mm) are contacted with lithium on the two opposite sides. These are subjected to cycling with increasing current density from 50 to 2000 μA/cm² with an increment of 50 μA/cm², and the voltage is recorded. One cycle is conducted for each current density, and the charging and discharging operations are each 30 min. The critical current density is defined as that current density at which there is a short circuit of the cell. At this current density, the voltage no longer follows current density according to Ohm's law, and there is instead an immediate drop in voltage.

Table 2 below shows the proportion of the amorphous phase and the critical current density CCD of example 1 and the two comparative examples V1 and V2.

TABLE 2

| | Ex. 1 | Ex. V1 | Ex. V2 |
|---|---|---|---|
| Amorphous phase [% | 3.8 | 0.1 | 1.3 |
| by wt.] | | | |
| CCD [mA/cm²] | 1.1 | 0.5 | 0.5 |

The specific use of the glass former SiO₂ in example 1 has made it possible to distinctly increase the proportion of the amorphous phase and critical current density by comparison with comparative examples V1 and V2.

In comparative example V2, the proportion of the amorphous phase was increased by about 10-fold via an increase in the proportion of Li₂O in the raw material composition by comparison with comparative example V1. Nevertheless, the CCD in V2 was unchanged compared to V1. Thus, an elevated proportion of glass formers, more preferably SiO₂, is especially also advantageous for a further increase in CCD.

1. A lithium ion-conducting material comprising a crystalline phase and an amorphous phase, wherein the lithium ion-conducting material has a critical current density of more than 0.5 mA/cm².

2. The lithium ion-conducting material of claim 1, wherein the amorphous phase comprises Li₂O and a glass former selected from the group consisting of SiO₂, B₂O₃, Al₂O₃, P₂O₅ and combinations of two or more thereof, wherein the content of glass formers based on the total mass of the lithium ion-conducting material is at least 0.05% by weight and wherein the total proportion of SiO₂ and P₂O₅ based on the total mass of glass formers is at least 25% by weight.

3. The lithium ion-conducting material of claim 2, wherein the proportion of SiO₂ based on the total mass of glass formers is at least 25% by weight.

4. The lithium ion-conducting material of claim 1, wherein the lithium ion-conducting material is a glass-ceramic.

5. The lithium ion-conducting material of claim 1, wherein the crystalline phase comprises a main crystal phase, wherein the main crystal phase has a proportion of the crystalline phase of at least 50% by weight and wherein the main crystal phase is in the cubic crystal system.

6. The lithium ion-conducting material of claim 1, wherein the crystalline phase comprises a main crystal phase, wherein the main crystal phase has a proportion of the crystalline phase of at least 50% by weight and wherein the main crystal phase has a garnet structure.

7. The lithium ion-conducting material of claim 5, wherein the main crystal phase comprises lithium lanthanum zirconate (LLZO).

8. The lithium ion-conducting material of claim 5, wherein the main crystal phase has the empirical formula Li_{7-3x+y-z}AlₓM_{y}^{II}M_{3-y}^{III}M_{2-z}^{IV}M_{z}^{V}O_{12±δ} where M^{II} comprises one or more divalent cations, M^{III} comprises one or more trivalent cations, M^{IV} comprises one or more tetravalent cations and M^{V} comprises one or more pentavalent cations, and where x+z>0, y<1 and δ<0.5.

9. The lithium ion-conducting material of claim 1, wherein the proportion of Li₂O in the amorphous phase is between 0.05% and 5.00% by weight based on the total mass of the lithium ion-conducting material.

10. The lithium ion-conducting material of claim 1, wherein the proportion of the amorphous phase in the lithium ion-conducting material is less than 5% by weight.

11. A process for producing a lithium ion-conducting material of claim 1, comprising the following steps:
melting the starting materials; and
cooling the melt.

12. A solid-state lithium ion battery comprising the lithium ion-conducting material of claim 1.

13. The solid-state lithium ion battery of claim 12, where in the lithium ion-conducting material is a separator.
